(19) United States
(12) Patent Application Publication
(10) Pub. No.: US 2014/0331179 A1
(43) Pub. Date: Nov. 6, 2014

(54) Automated Presentation of Visualized Data

(71) Applicant: MICROSOFT CORPORATION, Redmond, WA (US)

(72) Inventors: Steve Tullis, Redmond, WA (US); Uhl Albert, Kirkland, WA (US); David Gustafson, Boise, ID (US)

(73) Assignee: Microsoft Corporation, Redmond, WA (US)

(21) Appl. No.: 13/888,329

(22) Filed: May 6, 2013

(51) Int. Cl. G06F 3/0484; G06F 3/0482

(52) U.S. Cl. CPC G06F 3/04845; G06F 3/0482
USPC 715/811; 715/810

(57) ABSTRACT

A data visualization application provides an automated presentation of visualized data. A visualization of data is generated based on contextual information. Alternate visualizations displayed as actionable suggestions are also generated based on the contextual information. The application displays visualization and the actionable suggestions in proximity. The visualization is updated with an alternate visualization associated with a selected actionable suggestion in response to a user action selecting the actionable suggestion.

### BACKGROUND

People interact with computer applications through user interfaces. While audio, tactile, and similar forms of user interfaces are available, visual user interfaces through a display device are the most common form of user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render visual effects through a display and enable users to provide input associated with the applications' operations.

Modern platforms present data in textual form which is seldom combined with visual representations. In contemporary solutions data is usually presented to users in tables. Users select or define parameters for visualization of the presented data manually. Although, some portions of the data visualization are automated, such as ready-made charts, common data visualizations start with a user interaction. Subsequent data visualizations involve multiple user interactions with the data. Expansion of data analysis in the work place and personal lives necessitate elimination of manual user interactions while generating and updating data visualization for efficient utilization of data analysis.

Manipulation of visualized data is a source of additional difficulties associated with data visualization. In contemporary solutions, manual steps are needed in selecting visualization parameters (scale, axes, increments, style, etc.), range of data, and others. The manual aspects make data visualization counter-productive and counter-intuitive within the touch and/or gesture based intuitive and automated interaction environment of modern and future computing technologies.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automated presentation of visualized data. According to some embodiments, a data visualization application may generate a visualization of data and actionable suggestions associated with alternate visualizations based on contextual information. The contextual information may include user attributes, user preferences, organizational rules, use history, co-worker preferences, third party preferences, and similar ones. The application may display the generated visualization and actionable suggestions. The visualization may present data in visual form such as a graph, a chart, or similar ones. In addition, the actionable suggestions may be displayed adjacent to the visualization during rendering. Alternatively, the actionable suggestions may be displayed in response to a gesture.

Next, the application may detect a user action selecting of one of the actionable suggestions. The user action may be a gesture activating the actionable suggestion. In response to the user action, the visualization may be updated with one of the alternate visualizations associated with the selected actionable suggestion.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example concept diagram of automated presentation of visualized data according to some embodiments;

FIG. 2 illustrates an interaction diagram between entities involved in automated presentation of visualized data according to embodiments;

FIG. 3 illustrates an example of automated presentation of visualized data according to embodiments;

FIG. 4 illustrates another example of automated presentation of visualized data according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process for automated presentation of visualized data according to embodiments.

### DETAILED DESCRIPTION

As briefly described above, presentation of visualized data may be automated. A data visualization application may generate and display a visualization of data and actionable suggestions of alternate visualizations based on contextual information. The visualization may be updated with the alternate visualization of the selected actionable suggestion.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for automated presentation of visualized data. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

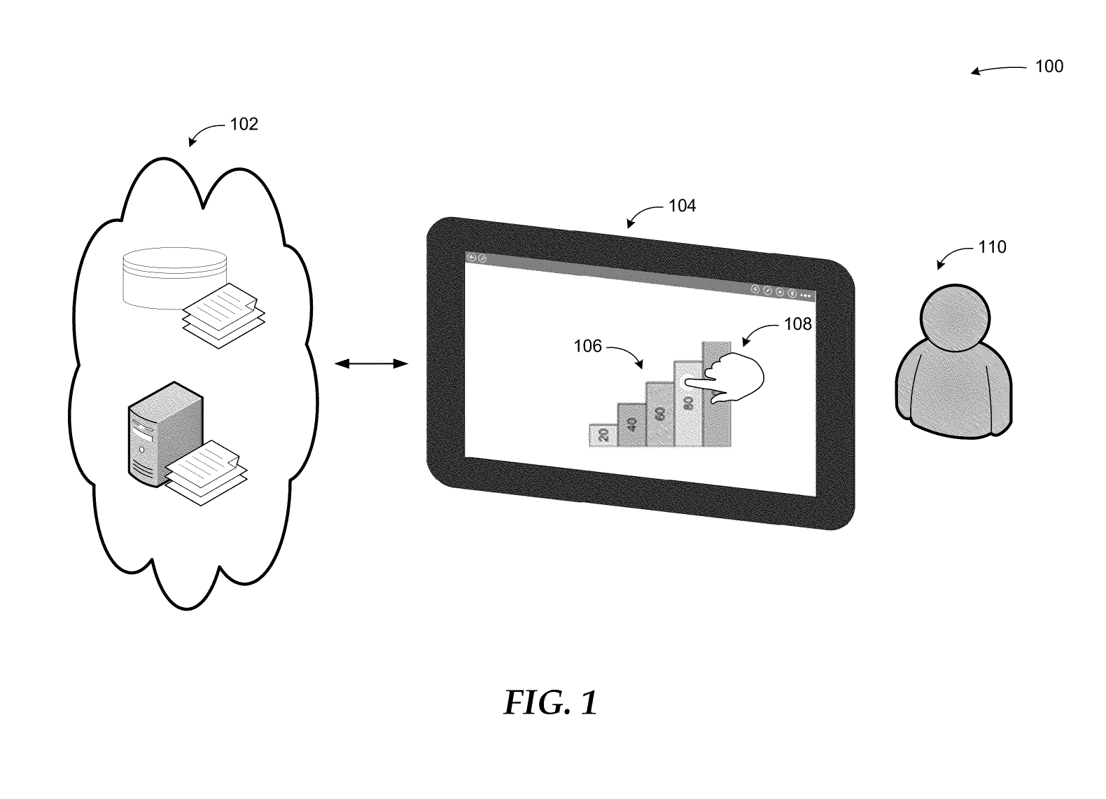

FIG. 1 illustrates an example concept diagram of automated presentation of visualized data according to some embodiments. The components and environments shown in diagram 100 are for illustration purposes. Embodiments may be implemented in various local, networked, cloud-based and similar computing environments employing a variety of computing devices and systems, hardware and software.

A device 104 may display a visualization 106 to a user 110. The visualization 106 is displayed by a data visualization application presenting visualizations. The visualization 106 may be a graph, a chart, a three-dimensional (3D) representation, a graphic, an image, a video, and comparable ones. The visualization 106 may be a presentation of underlying data. The data may be automatically presented as the visualization 106 to the user 110 based on contextual information. The application may use contextual information including user attributes, user preferences, organizational rules, use history, co-worker preferences, third party preferences, and similar ones to generate the visualization. The application may determine attributes of the visualization 106 based on the contextual information. In addition, the application may provide interactivity capabilities with the visualization 106 in response to a gesture 108 provided by the user 110. The device 104 may recognize the gesture 108 through its hardware capabilities which may include a camera, a microphone, a touch-enabled screen, a keyboard, a mouse, and comparable ones.

The device 104 may communicate with external resources such as a cloud-hosted platform 102 to generate the visualization 106. An example may include retrieving the data of the visualization 106 from the external resources. The cloud-hosted platform 102 may include remote resources such as data stores and content servers. The data visualization application may automatically generate the visualization 106 from the retrieved data based on contextual information associated with the user 110 and/or the data.

Embodiments are not limited to implementation in a device 104 such as a tablet. The data visualization application, according to embodiments, may be a local application executed in any device capable of displaying the application. Alternatively, the data visualization application may be a hosted application such as a web service which may execute in a server while displaying application content through a client user interface such as a web browser. In addition to a touch-enabled device 104, interactions with the visualization 106 may be accomplished through other input mechanisms such as an optical gesture capture, a gyroscopic input device, a mouse, a keyboard, an eye-tracking input, and comparable software and/or hardware based technologies.

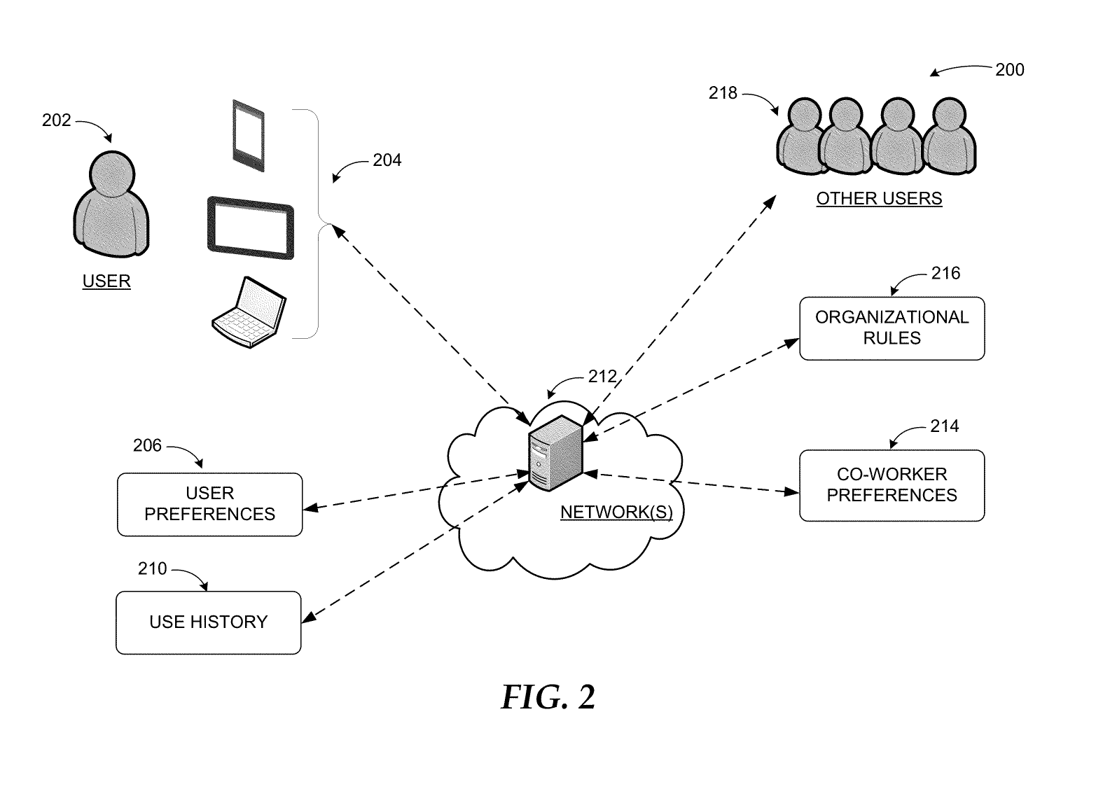

FIG. 2 illustrates an interaction diagram between entities involved in automated presentation of visualized data according to embodiments. Diagram 200 displays entities and a data visualization in a hosted platform automatically generating a visualization for presentation to user 202. Data associated with the visualization may initially be presented in visual from through the visualization instead of a traditional presentation of data in numerical form.

The data visualization application may execute in a hosted platform such as a cloud service within network(s) 212. The cloud service may include multiple devices and distributed application solutions. A hosted data visualization application may present generated data visualizations in client interfaces on devices 204. Alternatively, a local data visualization application may execute locally in devices 204 accessed by user 202 to view an auto-generated visualization.

In the illustrated example hosted platform of diagram 200, the data visualization application may determine contextual information to generate the visualization from variety of resources. The contextual information may be determined from attributes associated with the user 202, devices 204, user preferences 206, use history 210, other users 218 (third party), organizational rules 216, and co-worker preferences 214. In an example scenario, user preferences 206 may include a type, style, format, layout, and similar attributes which may be integrated into contextual information to be used for generating the visualization. Contextual information associated with user preferences 206 may also include animation, sizing, accessibility, and similar attributes of the visualization.

According to some embodiments, the application may determine contextual information from use history. Attributes of prior visualizations may be retrieved from use history. The attributes may be sorted based on length and frequency of use into a sorted list from a high use value to a low use value (or low to high use value). A predetermined number of sorted attributes from the top of the sorted list may be selected to integrate into the contextual information.

Additionally, the application may utilize contextual information from organizational rules 216 to generate a visualization of data for user 202. An example scenario may include retrieving an organization rule limiting a type attribute of the visualization to a bar chart, a line chart, a scatter chart, a pie chart, a surface chart, a donut chart, an area chart, a heat map, a spatial chart and similar one for documents prepared for the organization and integrating the type attribute into the contextual information.

According to some embodiments, other users 218 preferences may also be used as contextual information in generating the visualization automatically. Preferences of other users' (218) including type, format, style, layout, color, size, font and similar preferences may be retrieved and integrated into the contextual information. Similarly, preferences of co-worker preferences 214 may be retrieved from resources storing such information to use as contextual information in generating the visualization.

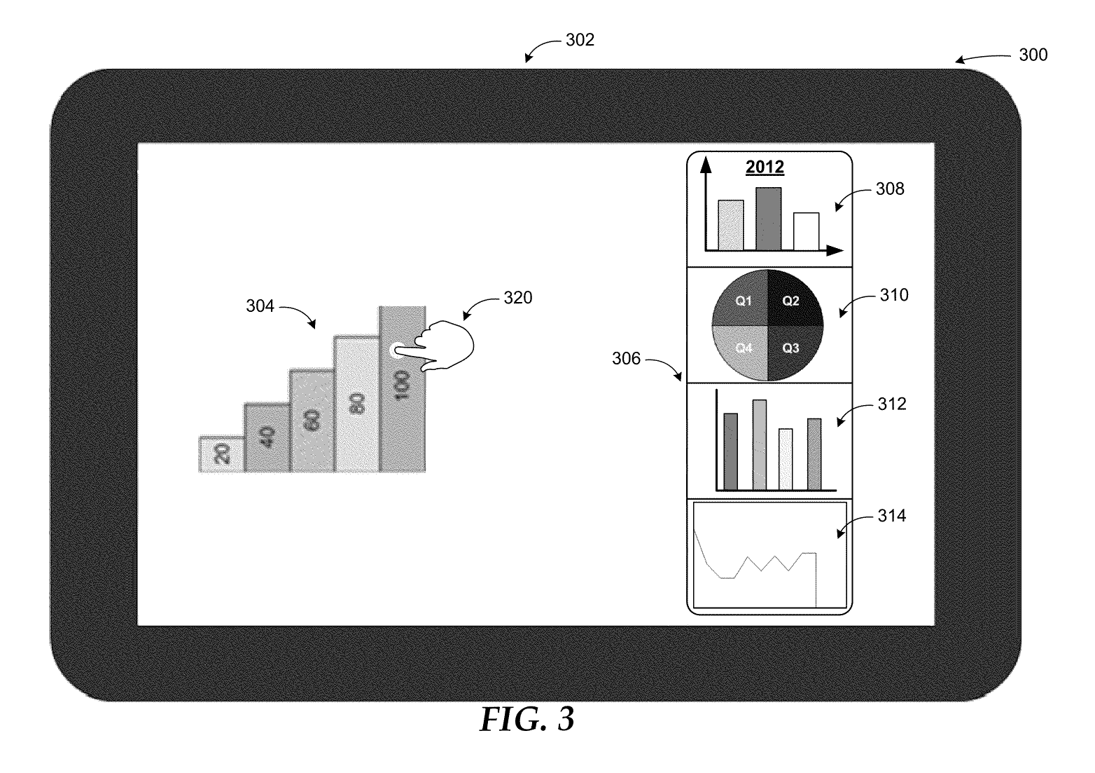

FIG. 3 illustrates an example of automated presentation of visualized data according to embodiments. Diagram 300 displays example of automatically suggesting (auto-suggest) alternate visualizations to the automatically generated visualization 304.

A data visualization application executing on device 302 (i.e.: a tablet) may automatically generate visualization 304. The visualization 304 may initially be rendered by device 302 to present the data associated with the visualization 304 in a visual form instead of traditional presentation of data in a numerical form. The visualization 304 may be generated based on contextual information associated with the user and other factors as previously described. Contextual information such as use history may be used to determine the alternate visualizations. In an example scenario, the application may sort prior visualizations based on frequency of use into a sorted list from a high frequency to a low frequency of use. The application may select a predetermined number of prior visualizations from the top of the sorted list. Attributes of the predetermined number of prior visualizations may be integrated into the contextual information.

The actionable suggestions 306 may be displayed in proximity to the visualization 304. In an example scenario, the application may display a bar chart 308, a pie chart 310, a 3D bar chart 312, and a line chart 314 as actionable suggestions 306. Attributes of the actionable suggestions 306 may be determined from contextual information including type, style, format, layout, and similar attributes. In addition, color, size, font, and similar attributes may be retrieved from contextual information to enforce organization rules defining visualization attributes for the visualization 304 and actionable suggestions 306.

A user action such as a gesture activating one of the actionable suggestions 306 may update the visualization 304 with an alternate visualization associated with the actionable suggestion. In an example scenario, in response to detecting a gesture selecting the bar chart 308, the application may replace the visualization 304 with an alternate visualization representing the data of the visualization 304 in an alternate form.

According to some embodiments, the actionable suggestions 306 may be displayed in response to detecting an interaction with a portion of the visualization 304 such as a gesture 320. The application may retrieve contextual information associated with factors including the user, the gesture 320, the data of the visualization, the data associated with a portion of the visualization, and similar ones. The application may determine alternate visualizations based on the contextual information.

In an example scenario, the alternate visualizations may be determined by matching the contextual information to a subset of prior visualizations from a data resource hosting visualization history. The application may match prior visualizations to the determined contextual information and select the matched prior visualizations as new alternate visualizations. New actionable suggestions of the new alternate visualizations may be presented in proximity to the visualization 304. Next, the application may update the visualization 304 with a new alternate visualization associated with one of the new actionable suggestions in response to another gesture selecting one of the new actionable suggestions.

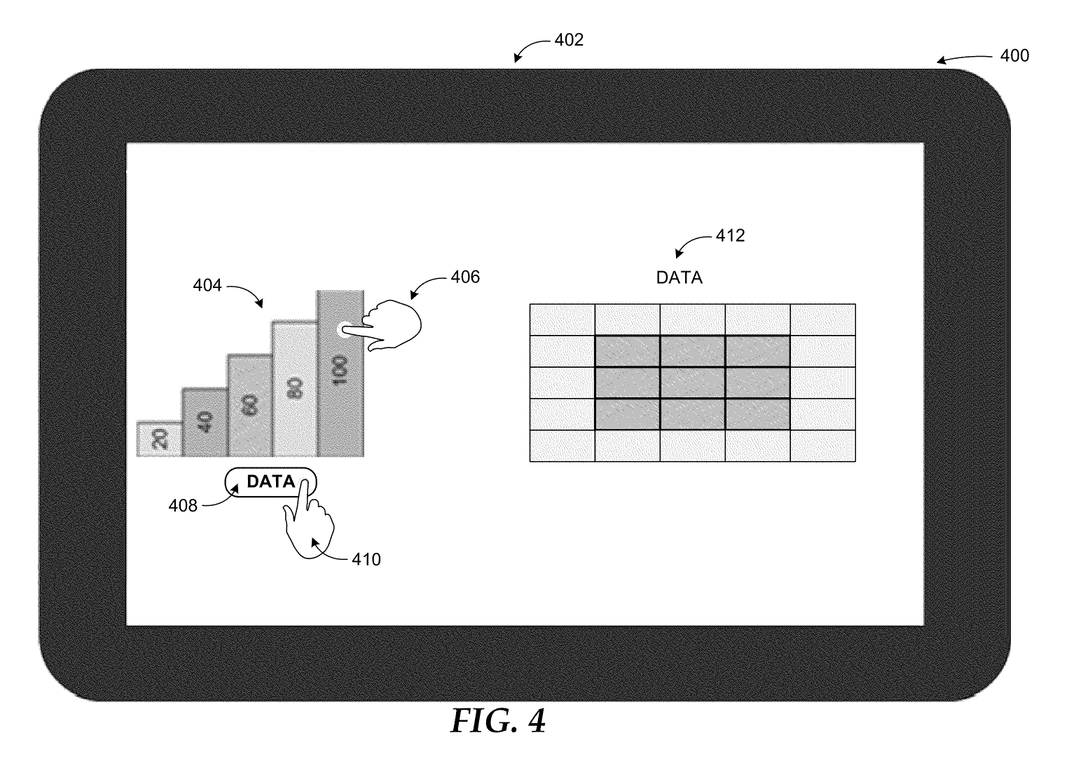

FIG. 4 illustrates another example of automated presentation of visualized data according to embodiments. Diagram 400 displays a device 402 providing access to data 412 of the visualization 404 through a data visualization application.

The data visualization application may display a data control 408 adjacent to visualization 404. The data control 408 may initiate an action to display data 412 associated with the visualization 404 in response to activation through a gesture 410. The data 412 may be displayed in proximity to the visualization 404. Alternatively, the data control 408 may be hidden. However, the data control 408 may be displayed in response to detection of another gesture requesting the data 412.

Alternatively, a gesture 406 detected on a portion of the visualization 404 may be interpreted to display data of the portion of the visualization 404 in proximity to the visualization. The data may be displayed in response to detecting the gesture 406.

According to some embodiments, the application may select data from structured or unstructured resources. Structured data may be data in tabular form. A visualization may be generated automatically based on all elements of the data or a portion of the data selected by the user. Additionally, a generated visualization may be customized according to contextual information including localization attributes. Localization attributes may include unit, language, style, and similar ones. Furthermore, the application may select a visualization type based on contextual information including a bar chart, a line chart, a scatter chart, a pie chart, a surface chart, a donut chart, an area chart, a heat map, and similar one. The dimension attribute of the visualization may also be selected from a two-dimensional (2D) or three-dimensional (3D) attribute stored in the contextual information.

According to other embodiments, the application may create an information catalog based on an index of data associated with the user and trends analysis. Trends analysis may include data analysis to capture use frequency of data attributes associated with the visualization and its data. The visualization or an update to the visualization may be created based on contextual information from the information catalog.

Embodiments are not limited to detection of a specific gesture used in an interaction with a visualization. The data visualization application may evaluate number of gestures including a pinch action, a spread action, a tap action, tap and hold, drag and drop, and similar ones to a combine, a split, a reduction, an expansion, and similar actions.

The example scenarios and schemas in FIG. 2 through 4 are shown with specific components, data types, and configurations. Embodiments are not limited to systems according to these example configurations. Automated presentation of visualized data may be implemented in configurations employing fewer or additional components in applications and user interfaces. Furthermore, the example schema and components shown in FIG. 2 through 4 and their subcomponents may be implemented in a similar manner with other values using the principles described herein.

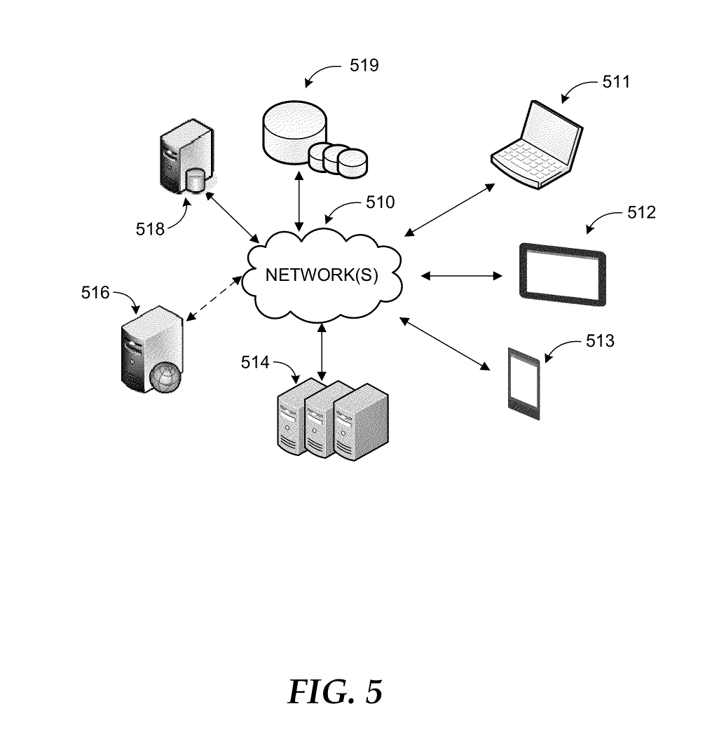

FIG. 5 is a networked environment, where a system according to embodiments may be implemented. Local and remote resources may be provided by one or more servers 514 or a single server (e.g. web server) 516 such as a hosted service. An application may execute on individual computing devices such as a smart phone 513, a tablet device 512, or a laptop computer 511 (‘client devices’) and communicate with a content resource through network(s) 510.

As discussed above, a data visualization application may generate and display a visualization of data and actionable suggestions based on contextual information. In response to a user action selecting one of the actionable suggestions, the application may update the visualization with an alternate visualization associated with the selected actionable suggestion. Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data resources, and data distribution systems may be employed to automate presentation of visualized data. Furthermore, the networked environments discussed in FIG. 5 are for illustration purposes only. Embodiments are not limited to the example applications, modules, or processes.

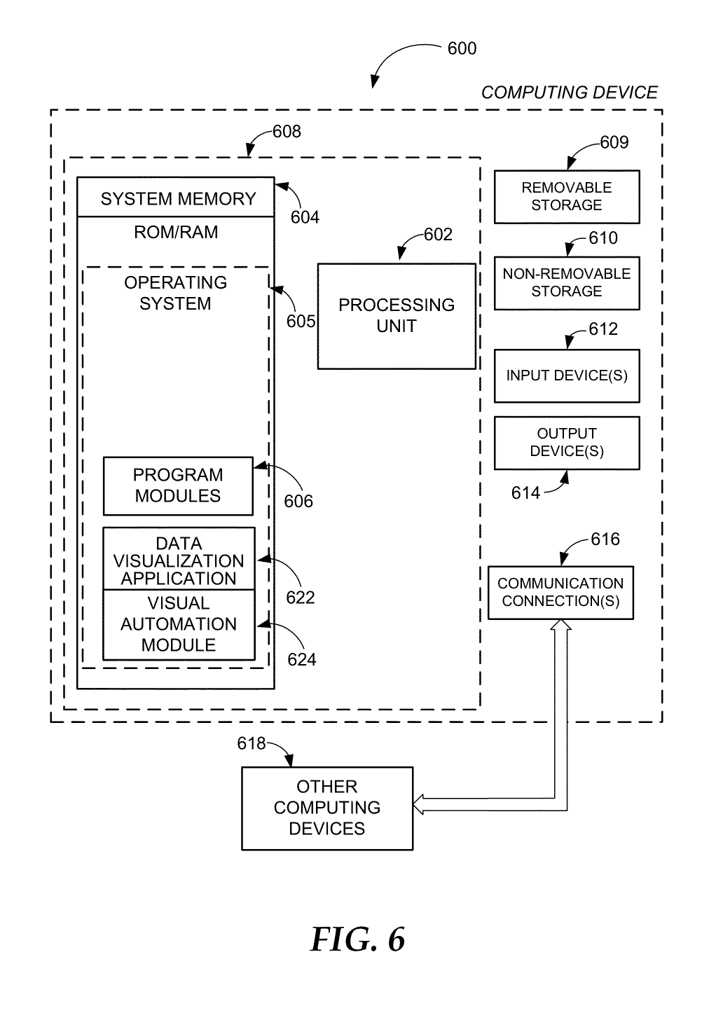

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® and WINDOWS PHONE® operating systems from MICROSOFT CORPORATION of Redmond, Wash. The system memory 604 may also include one or more software applications such as program modules 606, a data visualization application 622, and a visual automation module 624.

A data visualization application 622 may generate a visualization of data and actionable suggestions associated with alternate visualizations based on contextual information. The data visualization application 622 may display the visualization and the actionable suggestions in a screen of the device 600, in proximity. The visual automation module 624 may detect a user action selecting one of the actionable suggestions. And, the data visualization application 622 may update the visualization with an alternate visualization associated with the selected actionable suggestion. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

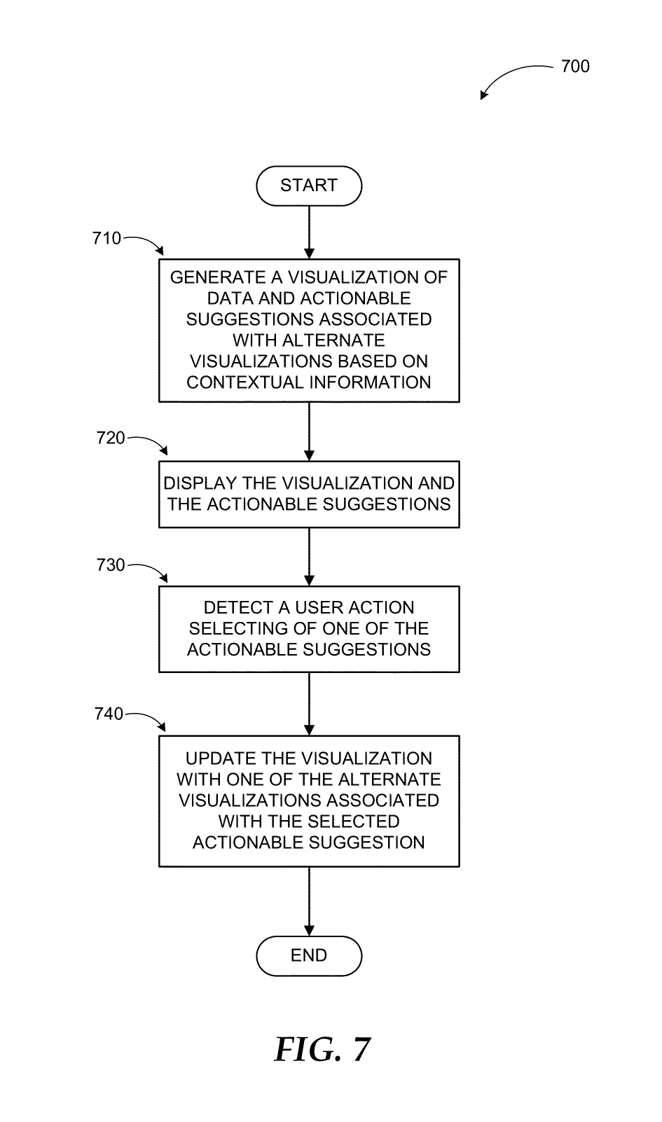

FIG. 7 illustrates a logic flow diagram for a process automating presentation of visualized data according to embodiments. Process 700 may be implemented by a data visualization application, in some examples.

Process 700 may begin with operation 710 where the data visualization application may generate a visualization of data and actionable suggestions associated with alternate visualizations based on contextual information. The contextual information may include user and visualization attributes. At operation 720, the visualization and the actionable suggestions may be displayed in proximity. The visualization may be a graph, a chart, and comparable ones of the data. Next, the application may detect a user action selecting one of the actionable suggestions at operation 730. At operation 740, the visualization may be updated with an alternate visualization associated with the selected actionable suggestion. The application may replace the visualization with the alternate visualization. Alternatively, the application may apply an update to the visualization by rendering updated components.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Automated presentation of visualized data, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method executed on a computing device for automated presentation of visualized data, the method comprising:
generating a visualization of data and actionable suggestions associated with alternate visualizations based on contextual information;
displaying the visualization and the actionable suggestions;
detecting an action selecting one of the actionable suggestions; and
updating the visualization with one of the alternate visualizations associated with the selected actionable suggestion.

2. The method of claim 1, further comprising:
determining the contextual information from attributes associated with at least one of: a user, the computing device, a user preference, a use history, a second user, an organizational rule, and a co-worker preference.

3. The method of claim 1, further comprising:
determining the contextual information from a plurality of user preferences including at least one of: a type, a style, a format, and a layout.

4. The method of claim 1, further comprising:
determining the contextual information from a plurality of user preferences including at least one of: an animation, a sizing, and an accessibility.

5. The method of claim 1, further comprising:
detecting selection of a portion of the visualization; and
displaying data associated with the visualization in proximity to the visualization by highlighting a portion of the data corresponding to the selected portion of the visualization.

6. The method of claim 5, wherein determining the contextual information based on the use history further comprises:
retrieving attributes of prior visualizations from the use history;
sorting the attributes based on a length and a frequency of use into a sorted list; and
selecting a predetermined number of the sorted attributes from a top of the sorted list for integrating into the contextual information.

7. The method of claim 1, further comprising:
determining the contextual information based on organizational rules.

8. The method of claim 7, further comprising:
retrieving an organization rule limiting a type of the visualization to at least one of: a bar chart, a line chart, a scatter chart, a pie chart, a surface chart, a donut chart, an area chart, a heat map, and a special chart; and
integrating the type into the contextual information.

9. The method of claim 1, further comprising:
determining the contextual information from a preference of at least one of: a second user and a co-worker.

10. The method of claim 9, further comprising:
retrieving attributes including at least one of: a type, a format, a style, a color, a size, a font from the preference; and
integrating the attributes into the contextual information.

11. A computing device for automated presentation of visualized data, the computing device comprising:
a memory configured to store instructions; and
a processor coupled to the memory, the processor executing a data visualization application in conjunction with the instructions stored in the memory, wherein the application is configured to:
generate a visualization of data and actionable suggestions associated with alternate visualizations based on contextual information;
display the visualization and the actionable suggestions in proximity to the visualization;
detect a gesture selecting one of the actionable suggestions; and
replace the visualization with one of the alternate visualizations associated with the selected actionable suggestion in response to the gesture.

12. The computing device of claim 11, wherein the application is further configured to:
determine attributes of the actionable suggestions including at least one of: a style, a format, a layout, a color, a size, and a font from the contextual information.

13. The computing device of claim 11, wherein the application is further configured to:
sort prior visualizations into a sorted list based on a frequency of use;
select a predetermined number of the prior visualizations from a top of the sorted list;
retrieve attributes from the predetermined number of the prior visualizations; and
integrate the attributes into the contextual information.

14. The computing device of claim 11, wherein the application is further configured to:
detect a second gesture interacting with a portion of the visualization;
match the second gesture to a subset of prior visualizations;
select the subset as new alternate visualizations; and
present new actionable suggestions associated with the new alternate visualizations in proximity to the visualization.

15. The computing device of claim 11, wherein the application is further configured to:
select a dimension attribute of the visualization including one of: a two-dimensional (2D) and a three-dimensional (3D) attribute stored in the contextual information.

16. The computing device of claim 11, wherein the application is further configured to:
select the data from at least one of: a structured data source and unstructured data source.

17. The computing device of claim 16, wherein the application is further configured to:
select a portion of the data; and
utilize the selected portion of the data to generate the visualization.

18. A computer-readable memory device with instructions stored thereon for automated presentation of visualized data, the instructions comprising:
generating a visualization of data and actionable suggestions associated with alternate visualizations based on contextual information;
displaying the visualization and the actionable suggestions in proximity to the visualization;
detecting a gesture selecting one of the actionable suggestions;
replacing the visualization with one of the alternate visualizations associated with the selected actionable suggestion in response to the gesture;
detecting a second gesture interacting with a portion of the visualization;
matching the second gesture to a subset of prior visualizations;
selecting the subset as new alternate visualizations; and
presenting new actionable suggestions associated with the new alternate visualizations in proximity to the visualization.

19. The computer-readable memory device of claim 18, wherein the instructions further comprise:
detecting activation of a data control; and
displaying the data of the visualization in proximity to the visualization.

20. The computer-readable memory device of claim 18, wherein the instructions further comprise:
displaying the data of a portion of the visualization in proximity to the visualization in response to a third gesture on the portion of the visualization.
